(19) United States
(12) Patent Application Publication
(10) Pub. No.: US 2012/0136883 A1
(43) Pub. Date: May 31, 2012

(54) Automatic Dynamic Multi-Variable Matching Engine

(76) Inventor: Christopher K. Kwabi, West Orange, NJ (US)

(21) Appl. No.: 13/305,738

(22) Filed: Nov. 28, 2011

Related U.S. Application Data
(60) Provisional application No. 61/417,412, filed on Nov. 27, 2010.

(51) Int. Cl. G06F 17/30

(52) U.S. Cl. 707/758; 707/E17.014

(57) ABSTRACT

An automated multivariable matching engine looks for matches between information entered into the engine by two different types of end users of the engine and when such matches occur, the engine determines if an event has occurred and, if so, reports the event to one or both of the different types of users and performs acts or tasks in accordance with user instructions that were included in the entered user information. In detecting matches and events based on the occurrence of matches, the engine creates new application domains, modifies existing application domains or removes existing applications domains. The engine thus changes it size and internal structure as necessary based on the occurrence of matches and events. Each event is defined by one or both of the end users for whom a match has occurred.

This application claims the benefit of the filing date of a provisional application entitled Automated Dynamic Multi-Variable Matching Engine having Ser. No. 61/417,412, which was filed on Nov. 27, 2010 and the disclosure of this provisional application is hereby incorporated herein by reference.

### BACKGROUND OF THE INVENTION

1. Field of the Invention

The present invention generally relates to a machine of end user information in various formats and more specifically relates to searching for matching information inputted by different end users of the machine.

2. Description of the Related Art

Since the advent of the Internet and its availability to the general public throughout the world, it has become more commonplace for private individuals, private and public organizations and any other entity imaginable to use the Internet as a virtual marketplace to search for and offer their goods and services to any potential interested party. There are various search engines available that allow anyone with a browser and access to the Internet to look for any sites that may be selling certain goods or services or sites that may be searching for specific goods and services or other items. It is often very difficult to actually locate the exact item or service on the Internet. Performing a keyword search many times does not lead to the desired result and often totally misses an existing matching site because of the particular keywords used in conducting the search. This problem of searching for an exact object, good or service occurrence or pattern is not only limited to Internet usage, but cuts across various scientific, marketing, technological and other disciplines where it is desirable to detect and document certain specific patterns and/or specific occurrences of events in a process that are key to understanding and or to properly analyze the process. Further, upon the occurrence of such patterns and/or events, it is often desirable to use such occurrences as triggers to initiate other processes. The end user input is often misunderstood or is not thoroughly processed to allow for detection of exactly what is being searched or exactly what is occurring in the process.

### BRIEF SUMMARY OF THE INVENTION

The present invention provides a device, a system and method for an Automated Dynamic Multivariable Matching engine (ADMME). The device of the present invention will hereinafter be referred to as a “matching engine.” The present invention thus provides a matching engine that dynamically alters its size and structure and adjusts it operation automatically in processing inputs and responding to matching end user inputs that qualify as internal events and/or external events. The internal events are defined by the end users and when an internal event occurs, it is reported by the matching engine to the end user that defined the event; that end user then performs certain acts or tasks in response to the occurrence of the event. Alternatively, the end user whose event has occurred may have instructions directing the matching engine to perform certain acts or tasks. Thus the matching engine allows end users to specify in great detail (using natural language in the form of voice, text, graphics, video or any combination thereof) the information they wish to convey or the information for which they are searching upon the occurrence of internal events.

Internal events are the manner in which matches occur as defined by at least one of the matching end users. External events are the manner in which information from end users or other external sources occur as detected by the matching engine. As end users enter information into the matching engine of the present invention at different times, the matching engine categorizes each such entry as belonging to an end user that is a member of a particular type of end users. Similarly, as information is entered into the matching engine from other external sources (e.g., other matching engines, programs, systems or any other non-human source of information), the matching engine also categorizes each such entry as belonging to an end user that is a member of a particular type of end users. The matching engine of the present invention is capable of processing information from at least two different types of end users. As information is entered into the matching engine from at least two different types of end users, the matching engine automatically adjusts its internal structure by removing, adding or modifying stored information associated with end users and forming or removing various links between end users and n-tuple Topics where such n-tuple Topics are generated by the matching engine from information entered by the end users. An n-tuple Topic describes certain characteristics (e.g., end user self description, or information for which an end user is searching) of an end user in the form of n variables (or components) where n is an integer equal to 1 or greater. The term n-tuple Topic is used interchangeably with n-tuple variable. Also, when it is necessary or desirable to do so, administrators can enter information into the matching engine to reconfigure it or update its various information storage locations. Further, as will be described herein, the administrators of the system may cause the matching engine to perform certain tasks upon detection of specific external events defined by the administrators.

In one embodiment of the matching engine of the present invention, an end user or other external source is categorized by the matching engine as a member of either a first type of end user or a second type of end user. The matching engine determines that an end user is a member of a first type of end user when said end user, for example, enters self-descriptive characteristic information the end user wishes to convey to a different end user type. The matching engine of the present invention categorizes an end user to be a member of the second type of end users when said end user, for example, enters information relating to certain end user characteristics for which the end user is searching. In one implementation of this embodiment, end users who are members of the first type are referred to as Producers. End users who are members of the second type are referred to as Consumers. End user characteristics relate to traits and/or descriptions about an end user's identity or skills that an end user may possess in one or more fields, disciplines or professions.

Part of the information entered by a Producer are instructions to the matching engine to publish an offer by the Producer to sell goods and/or provide services to one or more Consumers searching for those goods and/or services, i.e., when an internal event occurs that includes matches between what a Producer is offering and what one or more Consumers are searching. The interactions between Producer and Consumer are anonymous in that neither end user's identity is revealed to the other. However, there may be cases in which the identity of one or both of the end users (e.g., identity of Producer and/or Consumer) is revealed based on instructions from one or both of the end users. Thus, in publishing the offer of the Producer—depending on the instructions provided by the Producer—the matching engine may or may not publish the Publisher's identity. Also, depending on the instructions by the Producer, the publication performed by the matching engine is not necessarily solely based on the match, but may depend on the totality of instructions set by the Producer.

Similarly, part of the information entered by a Consumer are instructions to the matching engine to notify the Consumer when the particular services and/or goods being sought by the Consumer have been found; that is when an internal event has occurred that includes one or more matches between what the Consumer is searching for and what one or more matching Producers are offering, the matching engine notifies the Consumer of these one or more matches. The Consumer may perform additional tasks or generate instructions to the matching engine to perform these additional tasks/acts. In essence, a Producer wants to publish information, which may or may not include the Producer's identity, when an internal event as defined by the Producer has occurred. A Consumer subscribes to the matching engine to be notified by the matching engine when an internal event as defined by the Consumer has occurred.

The information entered by the Producers and Consumers may be in various forms such as voice, graphics, natural language text, video or any combination of these forms. The entered information are processed by a processor using natural language processing, Interactive Voice Response (IVR), parsing of natural language text or algorithms based on artificial intelligence that interpret videos, spoken or written language. The processor may be a microprocessor, microcomputer, microcontroller, a laptop computer, a desktop computer, a server, a plurality of processors operating cooperatively with each other to generate n-tuple variables that succinctly describe a Producer's offer of goods and/or services and/or the good/services being searched by a Consumer. Each n-tuple variable comprises n components some of which may be describing, for example, an end user's physical location (e.g., GPS coordinates), current time of day, particular goods/services being offered or being searched for, and the time period during which the particular goods/services are being searched or are being offered; n is an integer equal to 1 or greater. One or more components of the n-tuple variables may be continuously changing as a result of actions by the end user which actions are part of the n-tuple variables. In such cases, the end user may characterize part of the entered information as defining these continuously changing variables in terms of ranges of values. For example, an end user whose entry results in an n-tuple variable that includes the end user's location or the time of day may include in the entered information a range of values for the end user's location and a time period for which the entry is valid.

The matching engine and/or system of the present invention comprise a Producer Management module, an n-tuple Topic & Application Domain Management/Generator module, a Consumer Management module and an Application Domain Lookup Module (hereinafter referred to collectively as “the 4 input processing modules”) coupled respectively to L (an integer equal to 1 or greater) groupings of Producers, L groupings of n-tuple Topics and L groupings of Consumers. The processing relating to forming one grouping of Producers, one grouping of n-tuple Topics and one grouping of Consumers together constitute an application domain. These groupings can also be referred to as the Producer database, the N-tuple Topic database and the Consumer database respectively. Thus, the matching engine of the present invention comprises L domains where each domain comprises a Producer database, an N-tuple Topic database and a Consumer database and where each such database may or may not contain at least one entry.

Further, the matching engine and or system of the present invention comprise a Threshold Detector/Event Reporter coupled to the databases. Also, the Threshold Detector/Event Reporter and the four modules described above are coupled to an API (Application Program Interface) module. The API module has the proper functionality for allowing end users and administrators of the matching engine to gain access to and input information into the matching engine. Prior to being inputted to the API, the end user information is processed with various information processors such as such as natural language processors, interactive voice response (IVR) processors, processors capable of parsing natural language text or processors that execute algorithms based on artificial intelligence that interpret videos, spoken or written language or any combination thereof. These natural language processors are separate and apart from the API module. These various information processors extract the necessary information from the input information and feed the extracted information to the API module. Part or all of the extracting of information, such as extracting instructions from the end user information, can be done by the administrators of the matching engine and system of the present invention.

The matching engine can be a device where its various portions are co-located and the engine contains various processors or one main processor coupled electrically, electronically, electromagnetically or optically to the API, Threshold Detector/Event Reporter, and the four modules as described above. The term “couple” as used herein refers to a path that, under the control of one or more processors of the matching engine or system, facilitates the flow of information from one portion of the matching engine to another portion of the engine or to another portion of a system outside of the engine. The path may be an actual physical path (e.g., electrical, electronic, optic) or may be a logical path implemented through a data structure that allows information stored at certain memory locations to be retrieved by direct or indirect addressing. The operation of the data structure is controlled by one or more processors of the matching engine or system.

The present invention also includes a matching engine whose various parts may not be co-located but are coupled to each other via communication links or channels to process end user and administrator information. Such a matching engine is thus a system whose various parts are distributed in a fashion similar to a communication system where the various modules and processors are coupled to each other via communication links or channels.

As end users enter information into the matching engine, the information is processed by the natural language processors therein, and the resulting information is passed onto the API, which further processes the information to properly transfer its various parts to the modules (Producer Management module, N-tuple Topic & Application Management/Generator module and Consumer Management module) and the Threshold Detector/Event Reporter to determine its domain, if it exists, or create a new domain. In particular, the conditions (i.e., the end user's instructions) set by the end user under which the matching engine is to perform a task (e.g., publication of the Producer's identity and/or goods and/or services being offered by the Producer) when an end user-defined internal event has occurred is extracted from the end user's processed information by the Threshold Detector/Event Reporter.

The n-tuple Topic & Application Domain Management/Generator module creates a temporary n-tuple Topic from the entered information. If the created n-tuple Topic already exists, then it is not added to the n-tuple Topic database; otherwise it is added to the proper N-tuple Topic database in the proper application domain if such an application domain already exists. If there exists no proper application domain for the newly created n-tuple Topic, a new application domain is created. By definition an application domain refers to programming involving the modification, alteration, editing or creation of a database of Producers, a database of Consumers and a database of n-tuple Topics where each such database may have at least one entry. Also, the creation of a new application domain may not have new entries for one or more of the databases (i.e., no entry for Consumer or no entry for Producer or no entry for the n-tuple Topic database) and may comprise solely the addition of the new n-tuple Topic or the addition of a new Producer entry or the addition of a new Consumer into those respective databases. One embodiment may have “dummy” entries for a Consumer, Producer or n-tuple Topic.

The Producer and Consumer modules determine whether the end user is to be placed in the Producer or Consumer database of the proper application domain. The functions and the processing performed by the 4 input processing modules, the API, and the Threshold Detection/Event Reporter module are done for every existing domain. Once an end user is identified as either a Producer or Consumer and the end user's n-tuple Topic is inputted in the n-tuple Topic database, the matching engine links the end user to its n-tuple Topic. This linking of an end user to its n-tuple Topic is a logical link but can also be a physical path created between the end user and its n-tuple Topic so that the end user points to or has a path that leads directly to the location of the n-tuple Topic. The link can be implemented, for example, as a data structure wherein the end user is associated with an address showing where the n-tuple Topic is stored. The link is, therefore, a path that provides access to the n-tuple Topic and thus identifies such Topic to the matching engine whenever a task is to be performed by the matching engine.

Whenever a Producer and a Consumer in the same application domain are linked to the same n-tuple Topic a match occurs possibly triggering the reporting of an event and the performance of some type of task by the matching engine (e.g., by the Threshold Detection/Event Reporter) or by one or both of the matching end users. The Threshold Detection/Event Reporter documents the number of matches between the two matching end users and other information about the matches; for example, time of occurrence of the matches, rate at which matches occur and longest or smallest time gaps between the occurrence of the matches. This type of documenting of how the matches occur is dictated by the conditions set by the end users allowing the matching engine to report an internal event to the end users when such event has occurred; this type of documenting can also be dictated by the administrators of the engine. Thus, depending on the instructions set by the matching end users, the matching engine will report an event to one or both end users at the same time or at different times. For example, a Producer may want to publish its offering, but not its identity when the number of matches surpass a first threshold; when the number of matches surpasses a second threshold, the Producer would want to identify itself to all matching Consumers. Another example is where a consumer wants to be told that it has a match each time such a match occurs.

The matching engine of the present invention may operate under a default mode where the administrators cause the engine to perform certain tasks (e.g., publishing a Producer's offer) as soon as the Producer makes an offer to sell a goods and/or service. In some cases, Producers (also Consumers) may enter information where no specific good/service or specific amount of good/service is stated; or the stated good/service is described in general terms with no specificity. For example, the Producer may enter information that describes the Producer as a merchant of women's apparel with no specific apparel stated in the entered information. The administrators may decide to publish such goods/service or may decide to wait until the Producer (also Consumer) actually identifies, for example at a later time, the good/service with more specificity or the quantity of the good/service being offered.

The matching engine thus at any instant in time comprises one or more application domains each having a Producer database, a Consumer database and an n-tuple Topic database. Each such database may have no entries or one or more entries. The Producer or the Consumer or both databases may have links to one or more n-tuple Topic. The Producer and Consumer databases contain end user profiles. For example, an end user identified by the matching engine as a Producer (Consumer) has its profile stored in the Producer (Consumer) database. An end user may identify itself as a Producer or Consumer in the information it inputs into the matching engine and thus does not rely on the matching engine to characterize it as a Producer or Consumer. Links can be created and/or destroyed as necessary. Application Domains can be removed or created as necessary. Events are detected and trigger either an end user or the matching engine to perform a task (e.g., publishing Producer's offer) based on an end user's instructions. Thus, the matching engine is able to transform itself to different structures as it is operating.

The method of the present invention comprises various steps performed by the system and/or the matching engine (i.e., device) of the present invention to process information entered by two or more types of end users and information entered by administrators of the system or matching engine. Initially the method of the present invention provides at least one application domain comprising a grouping of the first type of end users, a grouping of n-tuple Topics, and a grouping of the second type of end users. The method of the present invention then processes end user information entered by end users where such end users may belong to a particular type of end users. There may be two or more end user types and such end users can be individuals, merchants, organizations, other systems, computers or any entity (human, machine or system) capable of conveying information in the forms discussed above (e.g., voice, video, text, graphics or any combination thereof). The method of the present invention processes the information entered by each end user to (a) determine the end user type (e.g., is the end user a Producer or Consumer), (b) generate an n-tuple Topic and (c) determine, document and store the end user's instructions in case an internal event (as defined by the end user) occurs.

The method of the present invention then determines to which existing application domain, if any, the generated n-tuple Topic belongs. If the generated n-tuple does not fit into any existing domain, the matching engine creates a new application domain that creates new storage space (i.e., a new grouping or database) for the end user and other end users of the same type. For the next step, the method of the present invention links or confirms the links of all the end users in the various databases within each application domain to their n-tuple Topic. When different types of end users are linked to the same n-tuple Topic, the method detects this as a match and further determines whether this match occurs with other conditions set by one or both of the matching end users possibly qualifying it as an internal event. If the match qualifies as an internal event for either of the matching end users, the matching engine performs the corresponding task or tasks set by one or both of the matching end users. Portions of the task/acts may be performed by the end user who defined the internal event. The task performed by the matching engine may include the removal of an end user or both end users and removal of links and possibly of application domains. Further, end users may set conditions on the amount of time or time period they exist in the matching engine and request the matching engine to remove them when the time period has elapsed.

In performing the tasks delineated by one or both matching end users, the method of the present invention may cause the matching engine to remove end users from the system, remove application domains, create new application domains, or add new n-tuple Topics (or remove n-tuple Topics) to (from) one or more of the existing application domains. In this manner the matching engine restructures itself as it operates over a particular time period. Also, the matching engine can operate using cloud processing as it is capable of obtaining readily available resources to support its dynamic operation. As new paths, new links, new memory storage locations and/or additional processing capabilities are needed to create new application domains, to create new links, to generate new n-tuple Topics, the matching engine of the present invention can be constructed with sufficient available resources to allow for such cloud processing. End users need not execute any of steps at their own sites, but simply need to have access to the matching engine to make use of the system. Access to the matching engine may be provided, for example, to clients of the owners and/or controllers of the matching engine, system of the present invention. Clients of the matching engine, or system are given access to the engine/system by the owner(s)/controller(s) so that the clients can then provide the matching engine/system to end users who can then use the engine/system as has been described above. Thus, clients act as a gateway or entry port to the matching engine of the present invention to provide the matching engine as a resource or tool to end users. For example, a client can have a website at which end users become members and thus can use the functionalities of the matching engine through applications created by the client in cooperation with administrators of the matching engine, system and method of the present invention. End users can be individuals, groups of individuals such as private, commercial, non-commercial and/or government organizations, systems or machines executing various processes or any entity able to generate end user information in the various forms described above. Clients can be, for example, commercial firms that provide cloud processing to end users. The administrators of the matching engine/system may alter the size and structure of the engine/system by adding/removing n-tuple Topics and adding or removing application domains. Administrators may create new application domains and n-tuple Topics in anticipation of certain information from possible end users of the matching engine and/or system of the present invention or in response to external events.

### BRIEF DESCRIPTION OF THE DRAWINGS

FIG. 1 shows a high level architecture of the Automated Dynamic Multi-Variable Matching engine of the present invention;

FIG. 2 shows a block diagram of the core of the matching engine of the present invention;

FIG. 3 shows one implementation of the matching engine and system of the present invention and how it can be used in cloud computing scenarios;

FIG. 4 is a flow chart of the method of the present invention.

### DETAILED DESCRIPTION

The present invention provides a device, a system and method for an Automated Dynamic Multivariable Matching engine (ADMME). The device of the present invention will hereinafter be referred to as a “matching engine.” The present invention thus provides a matching engine that dynamically alters its size and structure and adjusts it operation automatically in processing inputs and responding to matching end user inputs that qualify as internal events and/or external events. The internal events are defined by the end users and when an internal event occurs, it is reported by the matching engine to the end user that defined the event; that end user then performs certain acts or tasks in response to the occurrence of the event. Alternatively, the end user whose event has occurred may have instructions directing the matching engine to perform certain acts or tasks. Thus the matching engine allows end users to specify in great detail (using natural language in the form of voice, text, graphics, video or any combination thereof) the information they wish to convey or the information for which they are searching upon the occurrence of internal events.

Internal events are the manner in which matches occur as defined by at least one of the matching end users. External events are the manner in which information from end users or other external sources occur as detected by the matching engine. As end users enter information into the matching engine of the present invention at different times, the matching engine categorizes each such entry as belonging to an end user that is a member of a particular type of end users. Similarly, as information is entered into the matching engine from other external sources (e.g., other matching engines, programs, systems or any other non-human source of information), the matching engine also categorizes each such entry as belonging to an end user that is a member of a particular type of end users. The matching engine of the present invention is capable of processing information from at least two different types of end users. As information is entered into the matching engine from at least two different types of end users, the matching engine automatically adjusts its internal structure by removing, adding or modifying stored information associated with end users and forming or removing various links between end users and n-tuple Topics where such n-tuple Topics are generated by the matching engine from information entered by the end users. An n-tuple Topic describes certain characteristics (e.g., end user self description, or information for which an end user is searching) of an end user in the form of n variables (or components) where n is an integer equal to 1 or greater. The term n-tuple Topic is used interchangeably with n-tuple variable. Also, when it is necessary or desirable to do so, administrators can enter information into the matching engine to reconfigure it or update its various information storage locations. Further, as will be described herein, the administrators of the system may cause the matching engine to perform certain tasks upon detection of specific external events defined by the administrators.

In one embodiment of the matching engine of the present invention, an end user or other external source is categorized by the matching engine as a member of either a first type of end user or a second type of end user. The matching engine determines that an end user is a member of a first type of end user when said end user, for example, enters self-descriptive characteristic information the end user wishes to convey to a different end user type. The matching engine of the present invention categorizes an end user to be a member of the second type of end users when said end user, for example, enters information relating to certain end user characteristics for which the end user is searching. In one implementation of this embodiment, end users who are members of the first type are referred to as Producers. End users who are members of the second type are referred to as Consumers. End user characteristics relate to traits and/or descriptions about a end user's identity or skills that an end user may possess in one or more fields, disciplines or professions.

Part of the information entered by a Producer are instructions to the matching engine to publish an offer by the Producer to sell goods and/or provide services to one or more Consumers searching for those goods and/or services, i.e., when an internal event occurs that includes matches between what a Producer is offering and what one or more Consumers are searching. The interactions between Producer and Consumer are anonymous in that neither end user's identity is revealed to the other. However, there may be cases in which the identity of one or both of the end users (e.g., identity of Producer and/or Consumer) is revealed based on instructions from one or both of the end users. Thus, in publishing the offer of the Producer—depending on the instructions provided by the Producer—the matching engine may or may not publish the Publisher's identity. Also, depending on the instructions by the Producer, the publication performed by the matching engine is not necessarily solely based on the match, but may depend on the totality of instructions set by the Producer.

Similarly, part of the information entered by a Consumer are instructions to the matching engine to notify the Consumer when the particular services and/or goods being sought by the Consumer have been found; that is when an internal event has occurred that includes one or more matches between what the Consumer is searching for and what one or more matching Producers are offering, the matching engine notifies the Consumer of these one or more matches. The Consumer may perform additional tasks or generate instructions to the matching engine to perform these additional tasks/acts. In essence, a Producer wants to publish information, which may or may not include the Producer's identity, when an internal event as defined by the Producer has occurred. A Consumer subscribes to the matching engine to be notified by the matching engine when an internal event as defined by the Consumer has occurred.

The information entered by the Producers and Consumers may be in various forms such as voice, graphics, natural language text, video or any combination of these forms. The entered information are processed by a processor using natural language processing, Interactive Voice Response (IVR), parsing of natural language text or algorithms based on artificial intelligence that interpret videos, spoken or written language. The processor may be a microprocessor, microcomputer, microcontroller, a laptop computer, a desktop computer, a server, a plurality of processors operating cooperatively with each other to generate n-tuple variables that succinctly describe a Producer's offer of goods and/or services and/or the good/services being searched by a Consumer. Each n-tuple variable comprises n components some of which may be describing, for example, an end user's physical location (e.g., GPS coordinates), current time of day, particular goods/services being offered or being searched for, and the time period during which the particular goods/services are being searched or are being offered; n is an integer equal to 1 or greater. One or more components of the n-tuple variables may be continuously changing as a result of actions by the end user which actions are part of the n-tuple variables. In such cases, the end user may characterize part of the entered information as defining these continuously changing variables in terms of ranges of values. For example, an end user whose entry results in an n-tuple variable that includes the end user's location or the time of day may include in the entered information a range of values for the end user's location and a time period for which the entry is valid.

The matching engine and/or system of the present invention comprise a Producer Management module, an n-tuple Topic & Application Domain Management/Generator module, a Consumer Management module and an Application Domain Lookup Module (hereinafter referred to collectively as “the 4 input processing modules”) coupled respectively to L (an integer equal to 1 or greater) groupings of Producers, L groupings of n-tuple Topics and L groupings of Consumers. The processing relating to forming one grouping of Producers, one grouping of n-tuple Topics and one grouping of Consumers together constitute an application domain. These groupings can also be referred to as the Producer database, the N-tuple Topic database and the Consumer database respectively. Thus, the matching engine of the present invention comprises L domains where each domain comprises a Producer database, an N-tuple Topic database and a Consumer database and where each such database may or may not contain at least one entry.

Further, the matching engine and or system of the present comprise a Threshold Detector/Event Reporter coupled to the databases. Also, the Threshold Detector/Event Reporter and the four modules described above are coupled to an API (Application Program Interface) module. The API module has the proper functionality for allowing end users and administrators of the matching engine to gain access to and input information into the matching engine. Prior to being inputted to the API, the end user information is processed with various information processors such as such as natural language processors, interactive voice response (IVR) processors, processors capable of parsing natural language text or processors that execute algorithms based on artificial intelligence that interpret videos, spoken or written language or any combination thereof. These natural language processors are separate and apart from the API module. These various information processors extract the necessary information from the input information and feed the extracted information to the API module. Part or all of the extracting of information, such as extracting instructions from the end user information, can be done by the administrators of the matching engine and system of the present invention.

The matching engine can be a device where its various portions are co-located and the engine contains various processors or one main processor coupled electrically, electronically, electromagnetically or optically to the API, Threshold Detector/Event Reporter, and the four modules as described above. The term “couple” as used herein refers to a path that, under the control of one or more processors of the matching engine or system, facilitates the flow of information from one portion of the matching engine to another portion of the engine or to another portion of a system outside of the engine. The path may be an actual physical path (e.g., electrical, electronic, optic) or may be a logical path implemented through a data structure that allows information stored at certain memory locations to be retrieved by direct or indirect addressing. The operation of the data structure is controlled by one or more processors of the matching engine or system.

The present invention also includes a matching engine whose various parts may not be co-located but are coupled to each other via communication links or channels to process end user and administrator information. Such a matching engine is thus a system whose various parts are distributed in a fashion similar to a communication system where the various modules and processors are coupled to each other via communication links or channels.

As end users enter information into the matching engine, the information is processed by the natural language processors therein, and the resulting information is passed onto the API, which further processes the information to properly transfer its various parts to the modules (Producer Management module, N-tuple Topic & Application Management/Generator module and Consumer Management module) and the Threshold Detector/Event Reporter to determine its domain, if it exists, or create a new domain. In particular, the conditions (i.e., the end user's instructions) set by the end user under which the matching engine is to perform a task (e.g., publication of the Producer's identity and/or goods and/or services being offered by the Producer) when an end user-defined internal event has occurred is extracted from the end user's processed information by the Threshold Detector/Event Reporter.

The n-tuple Topic & Application Domain Management/Generator module creates a temporary n-tuple Topic from the entered information. If the created n-tuple Topic already exists, then it is not added to the n-tuple Topic database; otherwise it is added to the proper N-tuple Topic database in the proper application domain if such an application domain already exists. If there exists no proper application domain for the newly created n-tuple Topic, a new application domain is created. By definition an application domain refers to programming involving the modification, alteration editing or creation of a database of Producers, a database of Consumers and a database of n-tuple Topics where each such database may have at least one entry. Also, the creation of a new application domain may not have new entries for one or more of the databases (i.e., no entry for Consumer or no entry for Producer or no entry for the n-tuple Topic database) and may comprise solely the addition of the new n-tuple Topic or the addition of a new Producer entry or the addition of a new Consumer into those respective databases. One embodiment may have “dummy” entries for a Consumer, Producer or n-tuple Topic.

The Producer and Consumer modules determine whether the end user is to be placed in the Producer or Consumer database of the proper application domain. The functions and the processing performed by the 4 input processing modules, the API, and the Threshold Detection/Event Reporter module are done for every existing domain. Once an end user is identified as either a Producer or Consumer and the end user's n-tuple Topic is inputted in the n-tuple Topic database, the matching engine links the end user to its n-tuple Topic. This linking of an end user to its n-tuple Topic is a logical link but can also be a physical path created between the end user and its n-tuple Topic so that the end user points to or has a path that leads directly to the location of the n-tuple Topic. The link can be implemented, for example, as a data structure wherein the end user is associated with an address showing where the n-tuple Topic is stored. The link is, therefore, a path that provides access to the n-tuple Topic and thus identifies such Topic to the matching engine whenever a task is to be performed by the matching engine.

Whenever a Producer and a Consumer in the same application domain are linked to the same n-tuple Topic a match occurs possibly triggering the reporting of an event and the performance of some type of task by the matching engine (e.g., by the Threshold Detection/Event Reporter) or by one or both of the matching end users. The Threshold Detection/Event Reporter documents the number of matches between the two matching end users and other information about the matches; for example, time of occurrence of the matches, rate at which matches occur and longest or smallest time gaps between the occurrence of the matches. This type of documenting of how the matches occur is dictated by the conditions set by the end users allowing the matching engine to report an internal event to the end users when such event has occurred; this type of documenting can also be dictated by the administrators of the engine. Thus, depending on the instructions set by the matching end users, the matching engine will report an event to one or both end users at the same time or at different times. For example, a Producer may want to publish its offering, but not its identity when the number of matches surpass a first threshold; when the number of matches surpasses a second threshold, the Producer would want to identify itself to all matching Consumers. Another example is where a consumer wants to be told that it has a match each time such a match occurs.

The matching engine of the present invention may operate under a default mode where the administrators cause the engine to perform certain tasks (e.g., publishing a Producer's offer) as soon as the Producer makes an offer to sell a goods and/or service. In some cases, Producers (also Consumers) may enter information where no specific good/service or specific amount of good/service is stated; or the stated good/service is described in general terms with no specificity. For example, the Producer may enter information that describes the Producer as a merchant of women's apparel with no specific apparel stated in the entered information. The administrators may decide to publish such goods/service or may decide to wait until the Producer (also Consumer) actually identifies, for example at a later time, the good/service with more specificity or the quantity of the good/service being offered.

The matching engine thus at any instant in time comprises one or more application domains each having a Producer database, a Consumer database and an n-tuple Topic database. Each such database may have no entries or one or more entries. The Producer or the Consumer or both databases may have links to one or more n-tuple Topic. The Producer and Consumer databases contain end user profiles. For example, a end user identified by the matching engine as a Producer (Consumer) has its profile stored in the Producer (Consumer) database. A end user may identify itself as a Producer or Consumer in the information it inputs into the matching engine and thus does not rely on the matching engine to characterize it as a Producer or Consumer. Links can be created and/or destroyed as necessary. Application Domains can be removed or created as necessary. Events are detected and trigger either a end user or the matching engine to perform a task (e.g., publishing Producer's offer) based on a end user's instructions. Thus, the matching engine is able to transform itself to different structures as it is operating.

The method of the present invention comprises various steps performed by the system and/or the matching engine (i.e., device) of the present invention to process information entered by two or more types of end users and information entered by administrators of the system or matching engine. Initially the method of the present invention provides at least one application domain comprising a grouping of the first type of end users, a grouping of n-tuple Topics, and a grouping of the second type of end users. The method of the present invention then processes end user information entered by end users where such end users may belong to a particular type of end users. There may be two or more end user types and such end users can be individuals, merchants, organizations, other systems, computers or any entity (human, machine or system) capable of conveying information in the forms discussed above (e.g., voice, video, text, graphics or any combination thereof). The method of the present invention processes the information entered by each end user to (a) determine the end user type (e.g., is the end user a Producer or Consumer), (b) generate an n-tuple Topic and (c) determine, document and store the end user's instructions in case an internal event (as defined by the end user) occurs.

The method of the present invention then determines to which existing application domain, if any, the generated n-tuple Topic belongs. If the generated n-tuple does not fit into any existing domain, the matching engine creates a new application domain that creates new storage space (i.e., a new grouping or database) for the end user and other end users of the same type. For the next step, the method of the present invention links or confirms the links of all the end users in the various databases within each application domain to their n-tuple Topic. When different types of end users are linked to the same n-tuple Topic, the method detects this as a match and further determines whether this match occurs with other conditions set by one or both of the matching end users possibly qualifying it as an internal event. If the match qualifies as an internal event for either of the matching end users, the matching engine performs the corresponding task or tasks set by one or both of the matching end users. Portions of the task/acts may be performed by the end user who defined the internal event. The task performed by the matching engine may include the removal of a end user or both end users and removal of links and possibly of application domains. Further, end users may set conditions on the amount of time or time period they exist in the matching engine and request the matching engine to remove them when the time period has elapsed.

In performing the tasks delineated by one or both matching end users, the method of the present invention may cause the matching engine to remove end users from the system, remove application domains, create new application domains, or add new n-tuple Topics (or remove n-tuple Topics) to (from) one or more of the existing application domains. In this manner the matching engine restructures itself as it operates over a particular time period. Also, the matching engine can operate using cloud processing as it is capable of obtaining readily available resources to support its dynamic operation. As new paths, new links, new memory storage locations and/or additional processing capabilities are needed to create new application domains, to create new links, to generate new n-tuple Topics, the matching engine of the present invention can be constructed with sufficient available resources to allow for such cloud processing. End users need not execute any of steps at their own sites, but simply need to have access to the matching engine to make use of the system. Access to the matching engine may be provided, for example, to clients of the owners and/or controllers of the matching engine, system of the present invention. Clients of the matching engine, or system are given access to the engine/system by the owner(s)/controller(s) so that the clients can then provide the matching engine/system to end users who can then use the engine/system as has been described above. Thus, clients act as a gateway or entry port to the matching engine of the present invention to provide the matching engine as a resource or tool to end users. For example, a client can have a website at which end users become members and thus can use the functionalities of the matching engine through applications created by the client in cooperation with administrators of the matching engine, system and method of the present invention. End users can be individuals, groups of individuals such as private, commercial, non-commercial and/or government organizations, systems or machines executing various processes or any entity able to generate end user information in the various forms described above. Clients can be, for example, commercial firms that provide cloud processing to end users. The administrators of the matching engine/system may alter the size and structure of the engine/system by adding/removing n-tuple Topics and adding or removing application domains. Administrators may create new application domains and n-tuple Topics in anticipation of certain information from possible end users of the matching engine and/or system of the present invention or in response to external events.

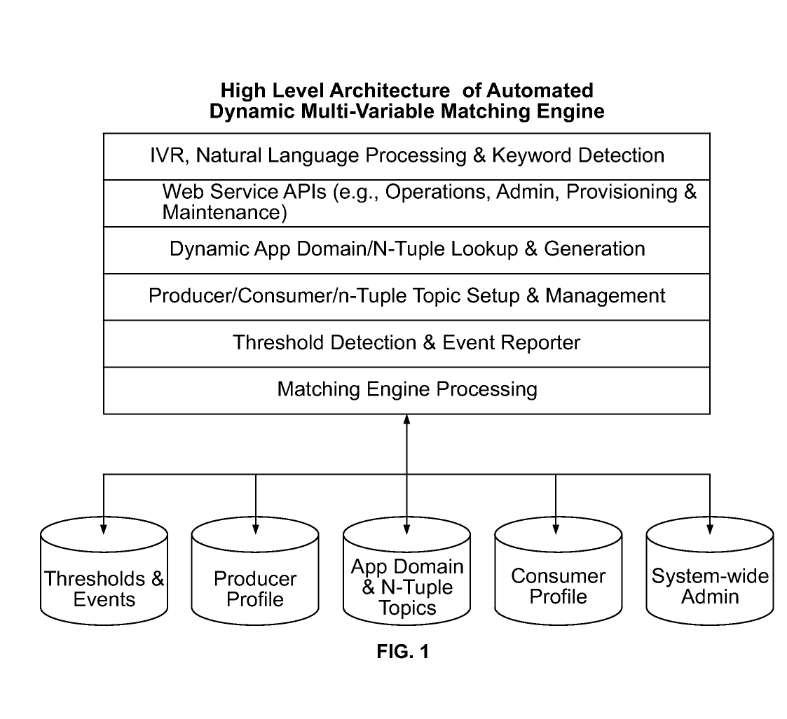

Referring now to FIG. 1 there is shown a high-level architecture diagram of the device and/or system of the matching engine of the present invention. For further ease of explanation the matching engine, system and method of the present will be described in the context of a computer network—that is, operation is done within a computer network—commonly referred to as the Internet or the World Wide Web. It will be readily understood, however, that the matching engine of the present invention can operate in various types of computer networks and is not limited to operate only within the Internet.

Continuing with the description of FIG. 1, the high level architecture is shown in terms of levels of functions of the matching engine. At the first level, the matching engine comprises different resources made available by the engine, system and method of the present invention such as natural language processors, interactive voice response processors that can serve as input processing of end user information (in the various forms discussed above) for the engine. At the next level, the matching engine, system and method of the present invention provides an Application Program Interface (API) (e.g., Web service API) that allows end users of the matching engine access to the matching engine and its resources. The API also enables administrators of the matching engine, system and method of the present invention to operate, control, maintain, update or otherwise modify the matching engine structure and function in automated fashion—either dynamically or statically—or in a manual fashion to provide available resources to end users and clients of the matching engine, system and method of the present invention. The Web service further allows the administrators to set up the engine to allow for a programmatic input (i.e., input applications or “input apps”) designed by clients of the matching engine, system and method of the present invention to properly interface with the API to ultimately enable end users to use the resources and functionalities and capabilities of the matching engine, system and method of the present invention.

For the next level of the architecture, the administrators of the matching engine may have an initial application domain that creates an initial database of n-tuple Topics. This initial database represents a starting point of the operation of the matching engine, system and method of the present invention. The information inputted in this database may be, for example, the result of extensive research of various topics where end users of computer networks want other end users of the same or different networks to know about them. The administrators of the system, device and method of the matching engine of the present invention may use already existing databases, indices of topics or may have performed their own proprietary research to generate such a database. As end users join the system and enter information into the matching engine, more application domains can be created, which may result in more n-tuple topics and more n-tuple Topic databases.

At the next level of the architecture each of the end users is categorized as either a Producer or Consumer based on the end user input information. Generically speaking, this level determines an end user type. An n-tuple Topic is typically generated for each such end user who is then linked to that n-tuple Topic.

The matching engine then extracts the conditions set by end users upon entering their information into the matching engine. The extracted conditions are used by a Threshold Detection/Event Reporter module of the matching engine to determine if and when an internal event has occurred, report the internal event to the proper end user and, if dictated by the matching end users, perform tasks set by one or both of the matching end users. One example of an internal event is the number of matches and/or type of matches that occur within the matching engine during operation. Another example of an event may be the rate at which matching Consumers are discovered or are added to the structure of the matching engine for a defined time period. Further, the event may be a set of instructions programmed in the Processor by the system administrators. There may be cases where the Producer does not have any conditions for revealing itself and transferring its information to any matching Consumers other than the occurrence of the match itself; thus the occurrence of a match may be an event. There may be circumstances where the administrators of the engine may want to perform tasks to update the system during its normal operation.

The next level performs matching engine processing where Producers and Consumers linked to the same n-tuple Topic are detected as a match. Such matching of Producers and Consumers are linked by paths (logical and/or physical paths) within the matching engine to allow, for example, Producers to reveal themselves to Consumers and/or to publish their goods/services to Consumers without necessarily revealing themselves. The Producers, for example, can simply send the description of their goods and/or services to the Consumers. In short, the engine and/or a matching Producer will perform the task set by the Producer upon the occurrence of an internal event. Also, the engine and/or a matching Consumer will perform the task set by the Consumer upon the occurrence of an internal event.

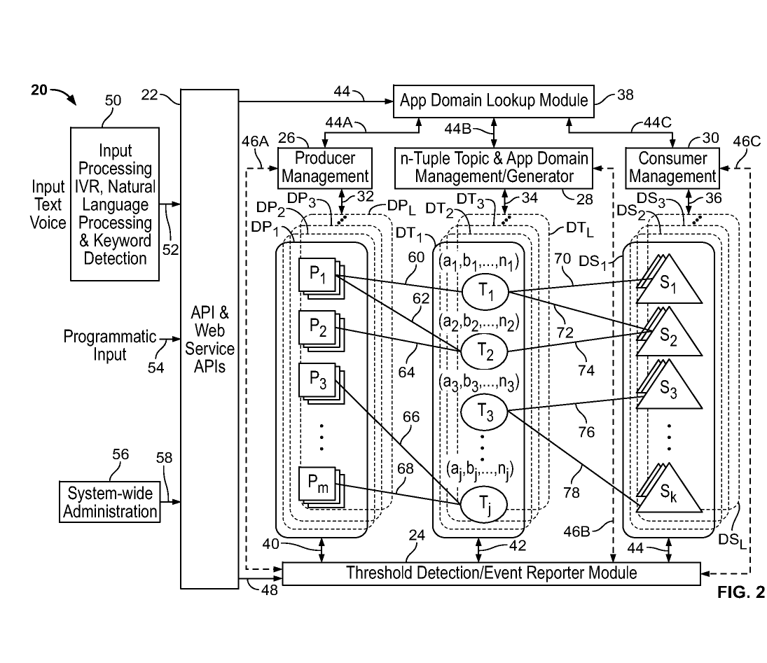

Referring now to FIG. 2, there is shown one embodiment in block diagram form of the matching engine 20 of the present invention. Producer Management module 26, N-tuple Topic & Application Domain Management/Generator module 28 and Consumer Management module 30 are coupled to L Producer databases (DP₁, DP₂, DP₃, . . . DP_{L}) via path 32, L n-tuple Topic databases (DT₁, DT₂, DT₃, . . . , DT_{L}) via path 34 and L Consumer databases (DS₁, DS₂, DS₃, . . . , DS_{L}) via path 36 respectively. The functionality that creates these three databases with at least two different types of end users is referred to as an application domain. As shown, in FIG. 2, there are L application domains. Each such database may have at least one entry or no entries. The Producer database, n-tuple Topic database and Consumer database, each is also coupled to the Threshold Detector & Event Reporter 24 via paths 46A, 46B and 46C respectively. API module 22 is coupled to App Domain Lookup module 38 via path 44 and is also coupled to the Threshold Detection & Event Reporter 24 via path 48. App Domain Lookup Module 38 is coupled to module 26 via path 44A, to module 28 via path 44B and to module 30 via path 44C. App Domain Lookup module 38 has the capability to review already created application domains to determine if the current user input information belongs in an already existing application domain. If the end user information belongs to an existing application domain, App Domain Lookup module 38 passes on the end user information to module 26 and to module 30 both which extract information inputted by an end user to determine whether such user can be categorized as a Producer or Consumer and store the end user's profile (i.e., End user type, email address, home address, cell phone, home phone, fax and other profile related information) in the Producer database or Consumer database accordingly. Further, App Domain Lookup Module transfers end user information to n-tuple Topic & App Domain Management/Generator module which creates an application domain and n-tuple Topics for the n-tuple Topic database which has a realm j meaning that such a database can contain j n-tuple Topics where j is an integer equal to 1 or greater. The databases can be formed from memory space available to the matching engine, system and method of the present invention; such memory space is under the control of the processor(s) of the matching engine of the present invention. The 4 input processing modules (38, 26, 28, 30) and Threshold Detection/Event reporter 24 can be implemented with one or more processors that have access to memory locations in case a piece of data or other information may need to be stored. The database for end-users categorized as Producers show that there are L such databases each having m Producers where m is an integer equal to 1 or greater. Similarly, the database for Consumers has k Consumers. Each of the n-tuple Topic databases has j n-tuple Topics where j is an integer equal to 1 or more; thus the n-tuple Topic databases are said to have a realm of j.

API module 22 provides a programmatic interface to the matching engine. The input at path 52 allows end users to enter information (voice, audio, video, graphics, text or any combination thereof) and have that information processed by processor 50. Processor 50 can use well-known techniques and/or algorithms to perform IVR (Interactive Voice Response) processing, natural language processing (NLP), processing of text, video, audio and graphics. Clients of the owners of the matching engine, system and method of FIG. 2 may design their own applications to interface to API module 22 to allow their end users to input information via module 50 and path 52 which ultimately is processed and routed by the 4 input modules and Threshold Detection/Event Reporter Module 24. External clients cooperate with administrators of the matching engine, system and method via the API module 22 to operate and process end user information inputted onto path 54 by the client. Administrators input information via path 58 from module 56. Module 56 may be one or more processors at one or different locations that allow administrators to maintain, update, control, set up the matching engine to allow outside application programs created by clients to interface via the API module 22 and otherwise monitor the matching engine, method and system of the present invention. When end user information is passed on from the API module to the 4 input modules via path 44 and to the Threshold Detection/Event Reporter module 24 via path 48, each such module extracts information to perform its function as has been described above. Each database interacts with Threshold Detection/Even Reporter Module 24 via paths 40, 42 and 44 respectively to allow module 24 to monitor these various databases and determine whether and when an internal event, as defined by an end user in an application domain has occurred. Module 24 can also determine when an external event as defined by administrators of the engine, system and method has occurred. External events may be information gathered by the engine as programmed by the system administrators to create new domains that can alert existing end users already in the system of possible new opportunities or new domains such users may have an interest. Application domains created by administrators of the system from external events are maintained, controlled or otherwise operated in the same manner as application domains created from internal events. Already existing end users and/or new end users can be part of these domains.

Continuing with the description of FIG. 2, the matching engine, system and method of the present invention is shown at a particular instant of time. It will be readily understood that the next instant of time may show a very different engine as new inputs to any and all of the domains may appear causing application domains to be created, modified and/or removed; Producers, Consumers and n-tuple Topics in any of the domains may change at the next instant of time. It is thus that the matching engine system and method of the present invention is able to change its form, structure and content from one instant of time to another. The engine shown in FIG. 2 at one particular time shows application domain 1 (of L application domains) has Producer P₁ linked to n-tuple Topics T₁ and T₂ via links 60 and 62 respectively; Producer P₂ is shown linked to n-tuple Topic T₂ via link 64; Producer P₃ is linked to n-tuple Topic Tⱼ and Producer Pₘ is also linked to linked to n-tuple Topic Tⱼ. Each of the n-tuple Topics of an application domain need not necessarily have the same number of variables. For example, in a specific application domain, a machine learning application dynamically expands the number of variables in an n-tuple topic. However, there may be application domains where it may be advantageous to have all of the n-tuple Topics have the same number of variables, i.e., where n is the same for all n-tuple Topics. Subscriber S₁ is shown linked to n-tuple Topic T₁ via link 70; Subscriber S₂ is shown linked to n-tuple Topics T₁ and T₂ via links 72 and 74 respectively; Subscriber S₃ is shown linked to n-tuple Topic T₃ via link 76 and Subscriber Sₖ is shown to be also linked to n-tuple Topic T₃, but via link 78. Thus, as shown, there exists a match between Producer P₁ and S₁, via n-tuple Topic T₁ and two matches between P₁ and S₂ via n-tuple Topic T₁ and T₂ respectively. Producers P₃ and Pₘ are both linked to n-tuple Topic Tⱼ, but are not matched to any Subscriber. Subscribers S₃ and Sₖ are both linked to n-tuple Topic T₃, but are not matched to any Producer. Also shown is modules 26, 28 and 30 are coupled to Threshold Detection/Event Reporter module 24 via paths 46A, 46B and 46C respectively shown in dashed lines for ease of illustration only; these paths operated in much the same manner as any other path in the engine, system and method of the present invention, but are shown in dashed line to allow for clarity in the illustration of FIG. 2. Paths 46A, 46B and 46C allow the modules 26, 28 and 30 to communicate with module 24 and allow module 24 to obtain information from the ether modules 26, 28 and 30 to determine whether an internal event has occurred for a particular instant application.

In the particular example depicted by FIG. 2, the first domain, which comprises Producer database DP₁, N-tuple Topic database DT₁, and Consumer database DS₁, shows that Producer database comprising m (an integer equal to 1 or greater) Producers, N-tuple Topic database DT₁ comprising j (an integer equal to 1 or greater) N-tuple Topics and database DS₁ comprising k Consumers. n-tuple Topic database DT₁ is said to have a realm of j Topics, where the realm j represents the number of Topics in the database. The first domain also shows several matches, viz., there is a match between Producer P₁ and Consumer S₁ as their respective links (60 and 70) point to the same N-tuple Topic T₁. There is a match between Producer P₂ and Consumer S₂ as their respective links (64 and 74) point to the same N-tuple Topic T₂. There is also a match between Producer P₁ and Consumer S₂ as their respective links (62 and 74) point to the same N-tuple Topic T₂. Note that Consumers S₁ and S₂ are not the same Consumer. The two consumers may have described the same or very similar goods and/or services for which they are searching. Also, note that Producer P₁ is linked to two different N-tuple Topics; this may occur as Producer P₁ may describe a good that it is offering and in the same entry, the same Producer P₁ is offering a service not closely related to the good being offered; thus N-tuple Topic T₂ may represent a good and N-tuple Topic T₁ may represent a service. Also, note that Producer Pₘ and Consumer Sₖ are not matched as their respective links (68 and 78) are coupled or point to N-tuple Topics T_{J} and T₃ with no corresponding Consumer and Producer linked to those Topics. The matching engine of the present invention may separate each offer into a different n-tuple Topic as shown. Alternatively, Producer P₁ may be offering various goods and/or services that may not be closely related to each other and thus the matching engine parses each such good/service and generates an n-tuple topic for each. A similar scenario may occur for Consumers where the Consumer in one entry is searching various goods or services not necessarily closely related to each other and thus the matching engine of the present invention would generate more than one N-tuple Topic for this particular Consumer.

The matching engine 20 as shown in FIG. 2 is the constitution of the matching engine for a particular instant in time. As end users are categorized as Producers and Consumers, and Domains are created and/or removed, and links are created or removed, the constitution of the machine changes accordingly. Further the particular links, n-tuple Topics, Producers and Consumers for the other L-1 domains are not shown for ease of illustration. It will be readily understood that such other components of the matching engine of the present invention are also changing in time based on occurrences of events, creation and removal of domains, creation of N-tuple Topics and other changes. The dynamic nature of the matching engine of the present invention allows it to automatically change its internal structure in response to end user inputs and occurrences of internal and external events. At a next instant in time, the machine shown in FIG. 2 may have drastically changed or remain virtually the same. The structure of the machine, and in particular the number of databases, the links between end users and N-tuple Topic, the number of a first type of end user and the number of a second type of end user in each domain, the number of N-tuple Topics in each domain, the number of domains may all be simultaneously changing in response to end user inputs and internal or external events.

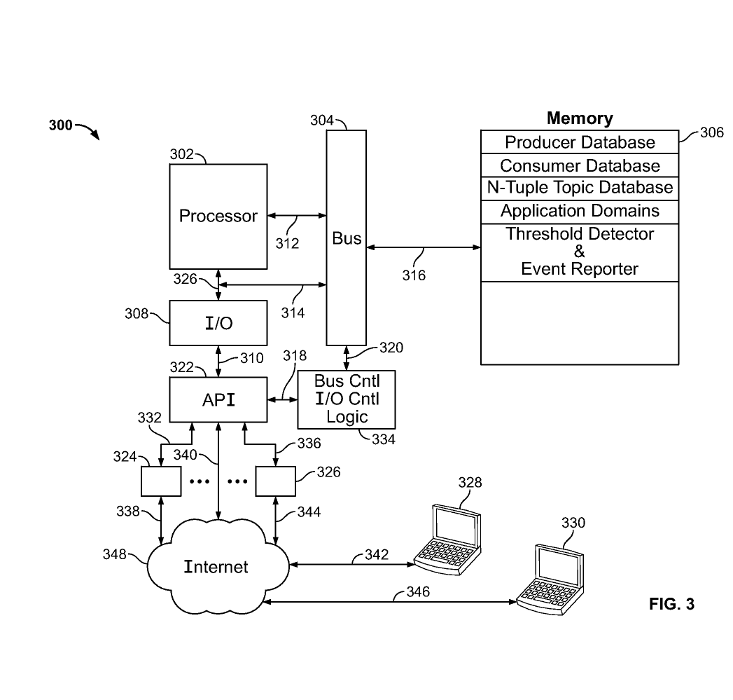

Referring now to FIG. 3, there is shown an implementation of the embodiment of the matching engine, system of the present invention. To place the matching engine in particular context where it is a cloud processing system having the resources necessary to accommodate the resource needs of the end users and administrators of the system, it is shown connected directly to the Internet 348 via communication link 340 or connected through the Internet 348 via particular servers 324, 326 of hosted clients of the matching engine, system. Two servers 324 and 326 are shown coupled to the matching engine via communication links 332 and 336 respectively. The servers are connected to the Internet 348 via communication links 338 and 344 respectively. Administrator 328 is able to communicate with the matching engine/system via communication link 342, the Internet 348 and communication link 340. End user 330 is able to gain access to the matching engine, system by accessing via communication link 346 a web site (not shown) located in the Internet, which web site is operated by a client of the owners of the matching engine or system. The website takes end user information and relays it to the matching engine or system via a server 324 dedicated to the website. Another server 326 for another website (also not shown) is depicted to show the matching engine or system of the present invention is able to engage a plurality of servers each of which may be serving one or more websites of clients of the owners of the matching engine or system of the present invention.

The particular cloud processing implementation of the matching engine of the present invention is shown in FIG. 3. Processor 302 is shown coupled to Memory 306 via path 312, Bus 304 and path 316. The I/O interface 308 is shown coupled to the Bus 304 via path 314 and to the Processor 302 via path 326. The Bus and Control Logic 334 is coupled to the Bus 304 via paths 326 and 314. An API module 322 is shown coupled to the Internet 348 via communication link 340 (also via servers 324 and 326 and their respective communication links as discussed above). The API module is also coupled to to I/O interface 308 via path 310. The various processing functions performed by the 4 input processing modules of FIG. 2 and the Threshold Detection/Event reporter module of FIG. 2 are implemented with Memory 306 and Processor 302; these processing modules can be implemented as applications executed by and with Processor 302 and portion of memory 306 as shown. The various components of the engine may not be co-located and may in fact be located at relatively large distances from each other making the engine operate more like a communication system where the various paths are communications channels complying with communication protocols and standards. Thus, the system/engine as shown in FIG. 3 can be a cloud processing system providing memory resources and processing resources at various different locations to accommodate the needs of the end users of the system. For example, memory 306 shown as one block of memory may actually be several remotely located large databases. The processor may be a plurality of processors all operating under a Master processor that is part of a server. The I/O module 308 may be one or more of standard hardware circuit (digital logic and/or sequential logic circuitry) devices that is part of or is designed to interact with such devices as a keyboard, a mouse, a laser pointer, a stylus, a joystick, a microphone, a webcam or any combination of these devices and other devices whose input can be monitored, deciphered and/or decoded by the Processor to allow the Processor to perform one or more tasks. The various components of the matching engine as shown in FIG. 3 can be implemented with hardware, software or firmware in well-known fashion. It is also possible to have the machine or a version of the machine implemented as a single server, a single desktop computer and/or a processor having the various logical circuitry controllable through firmware to perform the various functions, tasks and operation of the matching engine of the present invention as has been described throughout this disclosure.

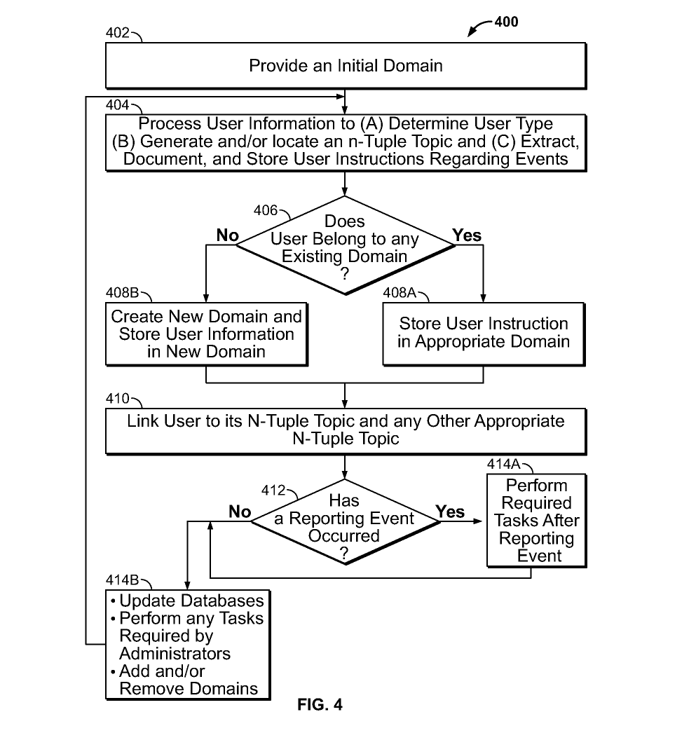

Referring now to FIG. 4 of the present invention wherein a flow chart of the method of the present invention is shown. In step 402, the method of the present invention provides an initial application domain for the matching, engine, system and method of the present invention. The application domain may have created the databases as described with respect to FIG. 2 where any one or all of the databases has one or more entries or no entries. In the embodiment discussed with respect to FIG. 2, corresponding Producer and Consumer databases are provided where each such database contains at least one end user that is linked to at least one N-tuple Topic. The initial application domain may have no end user linked to another end user. As end users enter the system and the system is operating properly, administrators will remove/add/modify application domains, end users, links between end users, and n-tuple Topics as dictated by occurrences of internal and external events.

In step 404, the method of the present invention processes end user information to determine an end user type, generate an N-tuple Topic and extract from the end user information instructions from the end user as to what tasks or actions are to be performed by the system or by the end user upon occurrence of an internal event as defined by the end user. Prior to the end user transmitting an offer or explaining the item or service it is searching for, the method of the present invention may prompt the end user in a quick answer/response session to obtain the end user profile information such as name, country of origin, resident or business address, email address, website URL (Uniform Resource Locator) address, cell phone number, business phone number, business fax number, home phone number and any other information deemed by the administrators to be necessary to allow the end user access to the method, matching engine and system of the present invention.

Once the end user has inputted its information the method of the present invention moves to step 406 where the method decides which existing domain, if any, is appropriate for the end user. Step 406 asks whether any of the existing application domain is appropriate for the user; that is does the user belong to any existing application domain. The end user may be a Producer with a relatively inexpensive laptop or desktop who has sent a video over the Internet explaining his offer in a relatively short video clip: for example, a cocoa farmer in Ghana who wishes to sell a specific amount of cocoa of a specifically defined quality at a particular location in Ghana accessible to aircraft and boats for a specific price range during a specified two month time period. The farmer explains in the video that he has a cell phone with text and email capability and that he would like to be contacted by phone at any time of the day by a potential buyer using text or email if there is one buyer willing to buy his cocoa at the stated amount for a price within the price range. The video is processed within the API module (or by separate natural language processor not necessarily embedded in the API module) as has been described earlier, to generate an N-tuple variable which may take the following form: (End user Type—Producer, farmer; Goods—cocoa; Amount being offered for sale—X lbs.; Price or price range—Between Y and Z dollars, Time period of offer: Jan. 1, 2012 to Feb. 1, 2012; Instructions: system allow potential buyer to contact farmer via text, email or phone.); this N-tuple Topic is actually a 4-tuple Topic (instructions and end user type are not part of the variable of an n-tuple Topic) having the following form: (Goods, Amount, Price, Time period). Having processed the end user information, if there are no existing application domains into which the end user can belong, the method of the present invention moves to step 408B where it creates a new domain which has a Producer database having one entry: Cocoa Farmer and an N-tuple Topic database comprising the 4-tuple Topic described earlier with said 4-tuple topic linked to the Cocoa farmer. Further the cocoa farmer's instructions are extracted from the video clip by the Threshold Detector/Event module and stored within said module so that this module is able to generate some type of code or logical sequence to perform the acts cited by the farmer upon the module's detection of an internal event as described by the farmer.

Another example of an end user is a Consumer roaming the streets of a metropolitan area searching for a merchant within a 3 mile radius that is selling cashmere sweaters made in Scotland; size: Large, color navy blue or brown and cost of less than $175.00. The Consumer's instructions to the system are to send him a text of the address of a corresponding Producer offering sweaters matching the Consumer's request. If the Producer does not want to be identified but is willing to provide an email address, the Consumer instructs the system not to interpret that occurrence as a match because the Consumer may think that the Producer is not a “brick and mortar” retailer but is simply an Internet business trying to sell its goods over the Internet using this system. The end user may be carrying a cellular phone with GPS capabilities allowing the cell phone to broadcast or transmit, during the search by the Consumer, the instantaneous GPS coordinates of the roaming Consumer. In this example, one of the components of the N-tuple Topic is a continuously varying component (i.e., the Consumer's instantaneous location). The Consumer may be prompted by the method of the present invention to give a range in locations for which his request may be valid. There may be Producers (i.e., retail stores or even sidewalk merchants) that may be offering such an item for sale with a price that falls within the price range of the Consumer and with a variety of colors some of which match the Consumer's color requirement. As the Consumer navigates within the 3 mile radius a match may occur and the method of the present invention would notify the Consumer of the Producer's location—this is assuming that the Producer is an end user of the system offering goods that include navy blue or brown cashmere sweaters made in Scotland available in Small, Medium and Large size selling for less than $175.00. Further, upon a match, the Producer has instructed the system to provide to any matching Consumer within a 50 mile radius of the Producer's street address, phone number and email address. Assuming there exists an application domain that is appropriate for this roaming Consumer, the method of the present invention moves to step 408A to store end user information (i.e., Consumer profile information), generate an n-tuple Topic, extract from the Consumer information instructions and store the instructions, n-tuple Topic and profile information into the Threshold Detector/Event Reporter of the matching engine and the various appropriate databases created by the application domain for this Consumer.

The method of the present invention then moves to step 410 where it links the newly stored end user to its corresponding N-tuple Topic and any other existing N-tuple Topic that may be appropriate for the end user. In step 412, the method checks for the occurrence of an internal event as defined by an end user. An event involves the occurrence of one or more matches and the manner such matches occur. It should be noted here that the matches need not be exact matches. The administrators of the method, system and engine of the present invention may declare a match when most of the n variables of an n-tuple Topic matches most of the corresponding n variables of another n-tuple Topic. That is, a match is not necessarily an exact match where all of the n variable of one end user matches all of the corresponding n variable of another end user. In step 414A the engine and/or end user or a combination of engine or end user performs the acts required by the end user upon detection of internal event, which is defined by the end user. Whether an event has occurred or not, the method of the present invention moves to step 414B where background administrative processes and or administrators of the system perform any necessary administrative task to ensure proper operation of the matching engine. Such task may include removing Producers, Consumers, removing application domains, creating additional links between end users and various N-tuple Topics, adding domains, accessing more resources in anticipation of increasing traffic and end user demands, and any other tasks deemed by the administrator to be necessary to maintain proper operation of the system, method and matching engine of the present invention.

The matching engine, system and method of the present invention can be used for various applications and is certainly not limited to the Producer/Consumer embodiment discussed herein. Some examples include the following:

### Meter Reading/Provisioning

Utility providers can use the system to dynamically service and provision meters out in the field. As technicians drive past meter locations, data can be dynamically sent to them as they approach the vicinity of the meters. In this scenario, the meters are producers that publish their respective readings to technicians (i.e. consumers) who are authorized to read the meters and are located in the immediate vicinity of the meter.

### Social Network Application

People can use this application to network professionally or socially. Using this system, users can dynamically match user profiles in a given geographic area to profiles in which they have previously declared an interest. For example, users at a conference would register themselves with this application along with characteristics of people that they are interested in meeting (picture, profession, college, etc). As the end user moves around from one location to another at conference, the application could identify potential matches that the user can approach. In this particular example the user is the Consumer that subscribes to a topic that represents the characteristics of individuals to whom they are trying to get introduced (i.e. the topic). Producers in this case are individuals willing to share their credentials and who are interested in meeting other people at the conference for networking and mentoring activities.

### Dynamic Persistent Search

In a marketplace for offering and finding rare or hard to find items, end users acting as Consumers submit a search item defining in detail an item that is hard to find. At some point one or more Producers of rare and hard to find goods may submit an offer in the system describing the availability of rare or hard to find items that matches the attributes of the rare item whose description/attributes were submitted by the above identified Consumer. When this occurs, the Consumer is notified of a match. The system continuously matches targeted offerings with targeted interests based on the attributes defined in the search criteria. The system can de configured to calibrate matches based on the degree of the matching attributes; that is in such search for rare items, non-exact matches may still be disclosed and there may be Consumers willing to buy such items.

### Dynamic Marketplace

Producers in this example would offer Commodities, Stocks, and other goods & Services along with their associated attributes at particular price points. Similarly, Consumers would provide a description of what they are searching along with their associated price points. Attributes defined by Producers and Consumers are converted into n-tuple topics which the system uses to dynamically match Producers and Consumers. Triggers can be defined to throttle when Producers publish their wares. Similarly, consumers can define various filters to control their visibility within the system. Generically, this particular application of the matching engine provides a dynamic market place where targeted offerings are matched with corresponding declared consumer interest.

### Dynamic Target Ad Engine

A Dynamic Targeted Ad Engine can be used to detect when targeted Ads from Producers can be offered to potential consumers who have previously opted in to participate.

A variation of the Dynamic Marketplace example above is to use the matching engine to supply highly targeted Advertisements from Producers to Consumers who have previously declared an interest in such Ads or the goods/services for which the Ads are made. Markets can be dynamically triggered by availability of Producers and/or consumers. Marketers would pay a fee to have access to these highly targeted consumers. Consumers can be incentivized to participate for example by offering them discounts in exchange for revealing their interests to potentially marketers.

### Data Mining Dynamics

In this application of the matching engine, metrics collected based on system usage are dynamically mined to detect patterns and trends that are subsequently used to adjust system configurations in reaction to changing conditions in the matching engine. These real time analytics can be used to provide data trending analysis and to predict future trends based on continuous analysis of matching data. New application domains can be created based on this data. Conversely, existing application domains can be torn down or adjusted based on the data. In this way the engine can operate like a living organism that organically grows and shrinks as it reacts to changing conditions in the engine.

### Generic Pattern Matching Engine

A potential application of this system is as a generic pattern matching system. Potential examples include Credit Card Fraud detection, Network Security Intrusion detection systems, and a DNA matching system.

In the Credit Card Fraud Detection System and or the Network Security Intrusion Detection System, the engine can be configured to dynamically inspect incoming data (Consumers) and look for specific patterns (Topics) that identify fraudulent activity. As soon as a potential match is found the appropriate systems (Producers) are notified to respond accordingly with the necessary corrective action.

Another potential application of this invention is to use it as a DNA matching system that can identify predispositions to particular ailments. Consumers submit their DNA to this system and the engine matches the incoming DNA with patterns of known diseases (topics) that exist in the system. When a match is found, details of the known ailment and potential remedies offered by an associated Producer (an expert in the particular field) linked to the topic are sent to the Consumers that submitted matching DNA samples.

Social Video/Music Matching application that matches users preferences with incoming video and or music feeds. In this example users are the Consumers, preferences are mapped to Topics and music and video assets within the incoming feeds are the Producers. Whenever a match is found the, consumers are notified of the specifics of the matching asset and can react accordingly.

The matching engine, system and method of the present invention have been described in terms of various embodiments as discussed herein. It will be readily understood that the embodiments disclosed herein do not at all limit the scope of the present invention. One of ordinary skill in the art to which this invention belongs can, after having this disclosure may implement the matching engine, system and method of the present invention using other implementations that are different from those disclosed herein, but which are well within the scope of the claimed invention.

What is claimed is:

1. An automated dynamic multivariable matching engine comprising:
a plurality of input modules;
a threshold detection/event reporter module coupled to the plurality of input modules; and
at least one application domain created by the input modules based on end user input information to detect matches between input information entered by different end users of the engine enabling the threshold detection/event reporter to determine an occurrence of an internal event defined by one of the end users causing the engine and/or at least one of the end users to perform a task or act in response to such internal event.
